(19) United States
(12) Patent Application Publication
(10) Pub. No.: US 2007/0251878 A1
(43) Pub. Date: Nov. 1, 2007

(54) Low volume per output large in-line filter assembly

(76) Inventors: Michael Saveliev, Huntington Beach, CA (US); Steven T. Jersey, Laguna Niguel, CA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/415,409

(22) Filed: May 1, 2006

(51) Int. Cl. B01D 35/00

(52) U.S. Cl. 210/418; 210/323.1; 210/450

(57) ABSTRACT

A low volume per outlet (LVPO) large in-line filter and quick disconnect valve. The LVPO filter can include inlet and outlet ports perpendicular to a longitudinal axis of the filter. A semi-spherical end-cap and an inlet can produce a laminar flow. The inlet and outlet can include quick connect couplings for connecting and disconnecting hoses. A quick disconnect valve can enable filter replacement.

### BACKGROUND

Filters are commonly used to purify liquids, such as water and syrups for beverage dispensers. In-line filters, which have an inlet at one end out an outlet at the other end, are convenient for many different filter applications. An in-line filter, in its simplest form, is a hollow vessel holding a filtration medium that has an inlet port at one end and an outlet port at the other end. The inlet and output ports generally include fittings for connecting supply and drain tubing or hoses.

### SUMMARY

In one embodiment, the invention provides an in-line filter assembly including a filter sub-system, a housing, and an end-cap. The housing can receive the filter sub-assembly. The end-cap can include an inlet and can have a semi-spherical shape. The inlet and the semi-spherical end-cap can produce a laminar flow. The in-line filter can include a valve that can be coupled to the inlet port.

In some embodiments, the invention provides an in-line filter including an end-cap, a housing, a filter sub-assembly, and quick connect couplings. The end-cap can have a semi-spherical shape and an inlet. The end-cap and the inlet can produce a laminar flow. The housing can include an outlet. The inlet and the outlet can be positioned substantially perpendicular to a longitudinal axis of the housing. The filter sub-assembly can be positioned in the housing. Quick connect couplings can be coupled to the inlet and the outlet.

Other aspects of the invention will become apparent by consideration of the detailed description and accompanying drawings.

### BRIEF DESCRIPTION OF THE DRAWINGS

FIG. 1 is a perspective view of a low volume per output (LVPO) large in-line filter according to one embodiment of the invention.

FIG. 2 is an exploded perspective view of the LVPO filter of FIG. 1.

FIG. 3 is an end perspective view of a housing of the LVPO filter of FIG. 1.

FIG. 4 is a cross-sectional side view of the housing of the LVPO filter of FIG. 1.

FIG. 5 is a perspective view of an inlet end-cap of the LVPO filter of FIG. 1.

FIGS. 6A and 6B are perspective views of a filter sub-assembly of the LVPO filter of FIG. 1.

FIG. 6C is a perspective view of a filter inlet end-cap of the filter sub-assembly of FIGS. 6A and 6B.

FIG. 6D is a perspective view of a filter outlet end-cap of the filter sub-assembly of FIGS. 6A and 6B.

FIG. 7 is a cross-sectional view of the housing and the filter sub-assembly of the LVPO filter of FIG. 1.

FIG. 8 is a cross-sectional view of a quick disconnect ball valve according to one embodiment of the invention for use with the LVPO filter of FIG. 1.

FIG. 9 is an exploded perspective view of the LVPO filter of FIG. 1 and the quick disconnect ball valve of FIG. 8 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

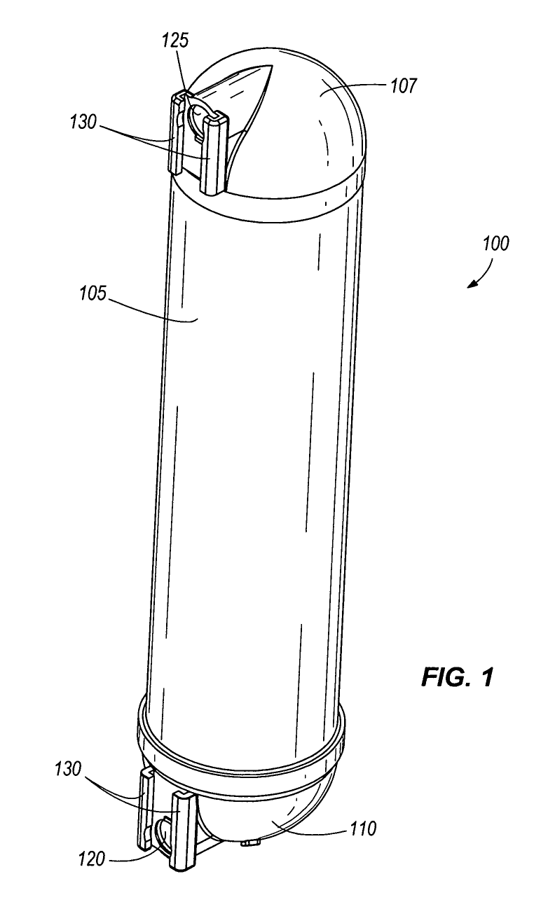

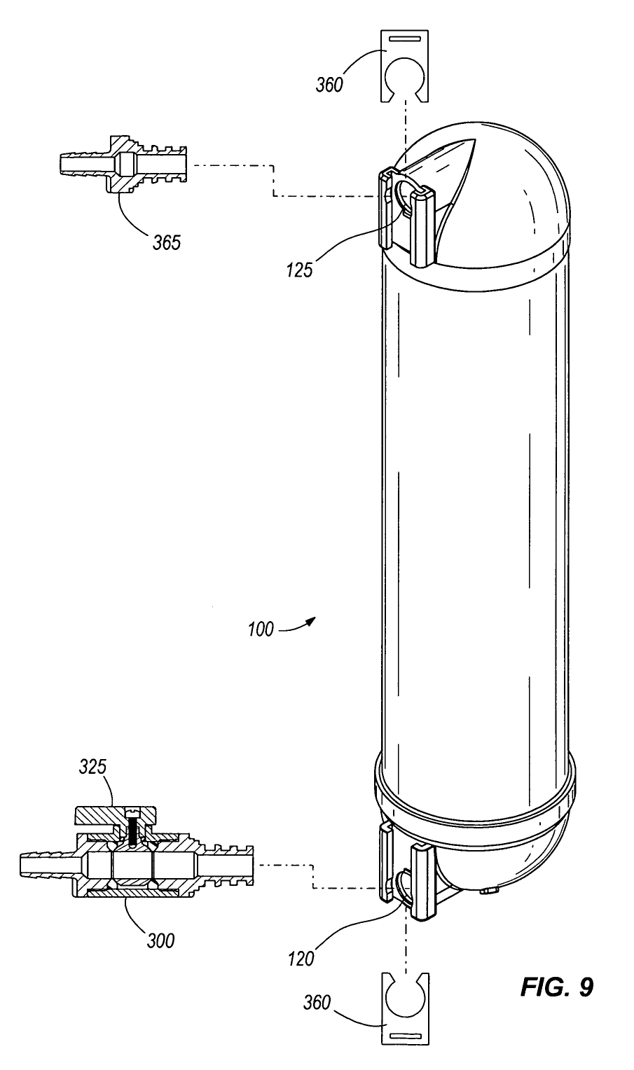

FIG. 1 illustrates a low volume per outlet (“LVPO”) large in-line filter 100 according to one embodiment of the invention. The LVPO filter 100 can include a cylindrically-shaped housing 105, an outlet end-cap 107, and an inlet end-cap 110. The end-caps 107 and 110 can be semi-spherically shaped. An inlet port 120 and an outlet port 125 can extend from the inlet end-cap 110 and the outlet end-cap 107, respectively. The inlet port 120 and outlet port 125 can extend perpendicular to a longitudinal axis of the housing 105. In one embodiment, the inlet port 120 and the outlet port 125 can be cylindrical in shape in order to receive a cylinder-shaped nozzle or fitting. The ports 120 and 125 can each include two coupling guides 130 that can receive a quick connect coupling clip 360 (as shown in FIG. 9).

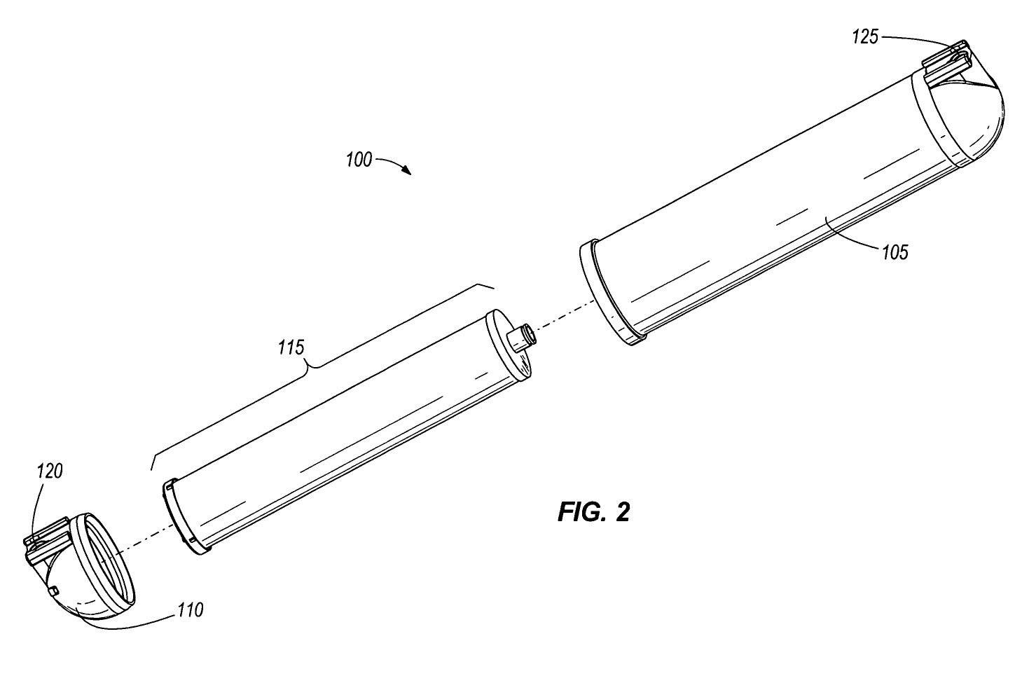

FIG. 2 illustrates an interior chamber of the LVPO filter 100 that can receive filter media 115, such as a filter sub-assembly 140. The LVPO filter 100 can be positioned in the flow of a liquid to filter out impurities in the liquid. The liquid can be supplied to the inlet port 120 and can enter the housing 105 where the liquid can pass through the filter sub-assembly 140. As the liquid passes through the filter sub-assembly 140, the filter sub-assembly 140 can remove impurities in the liquid. The filtered liquid can then flow out of the outlet port 125.

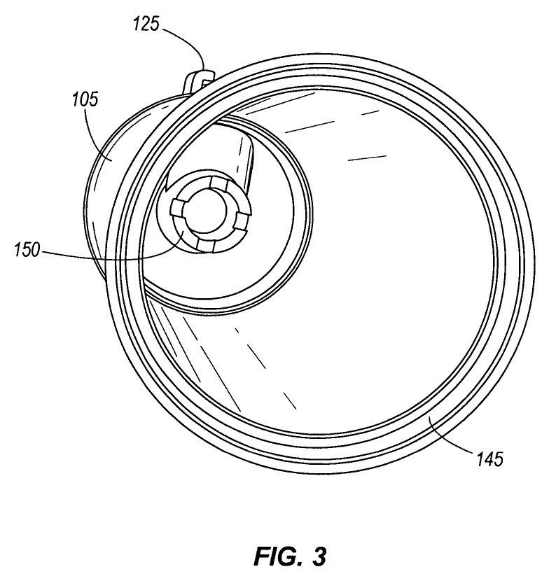

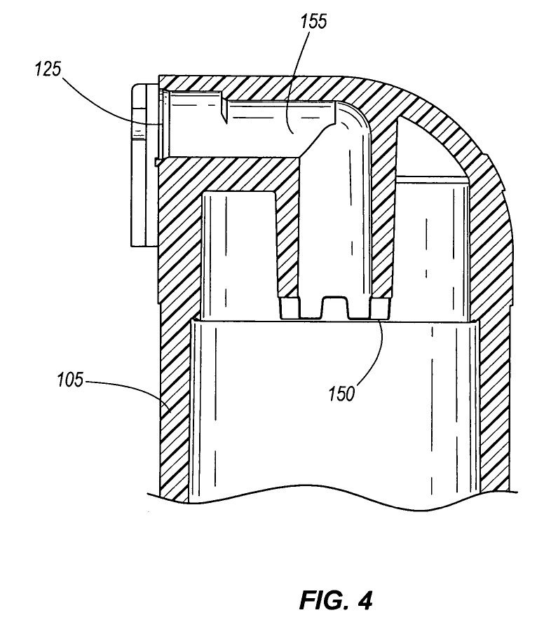

FIGS. 3 and 4 illustrate the interior chamber of the housing 105 and the outlet end-cap 107. In some embodiments, the outlet end-cap 107 can be integrally formed with the housing 105. As shown in FIG. 3, the housing 105 can include screw threads 145 for attaching the inlet end-cap 110. As shown in FIGS. 3 and 4, the outlet port 125 can be connected to an outlet port access 150. The outlet port access 150 can lead to an outlet tube 155. The outlet tube 155 can extend along the longitudinal axis of the housing 105 to a point near an end of the outlet end-cap 107. As shown in FIG. 4, the outlet tube 155 can include a 90 degree bend to also extend perpendicular to the longitudinal axis of the housing 105 and to meet the outlet port 125. A filtered liquid can enter the outlet port access 150, pass through the outlet tube 155, and travel out of the outlet port 125.

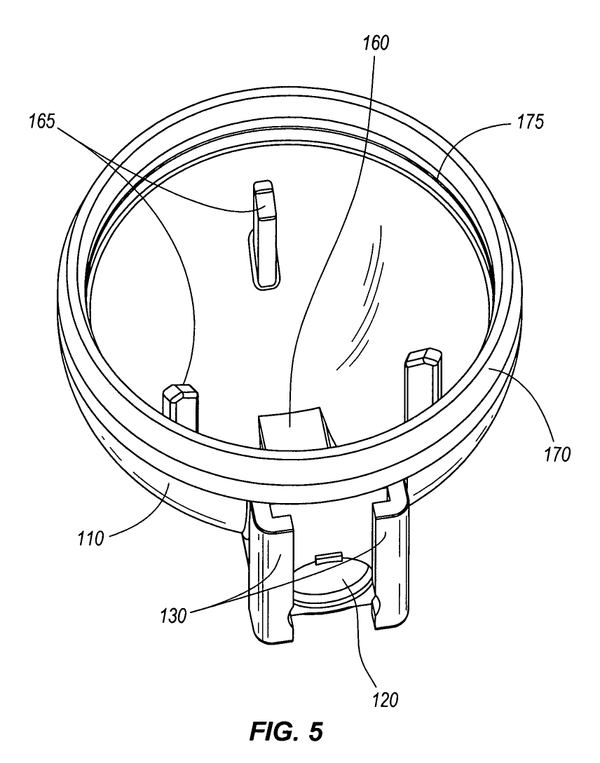

FIG. 5 illustrates one embodiment of the inlet end-cap 110. The inlet end-cap 110 can have a semi-spherical shape. The inlet port 120 can open into the interior of the inlet end-cap 110. A channel 160 can guide the flow of a liquid entering the LVPO filter 100. One or more posts 165 can hold the filter sub-assembly 140 in a desired position offset from the semi-spherical wall of the inlet end-cap 110. Screw threads 170 can be used to attach the inlet end-cap 110 to the housing 105. The inlet end-cap 110 can also include a lip 175.

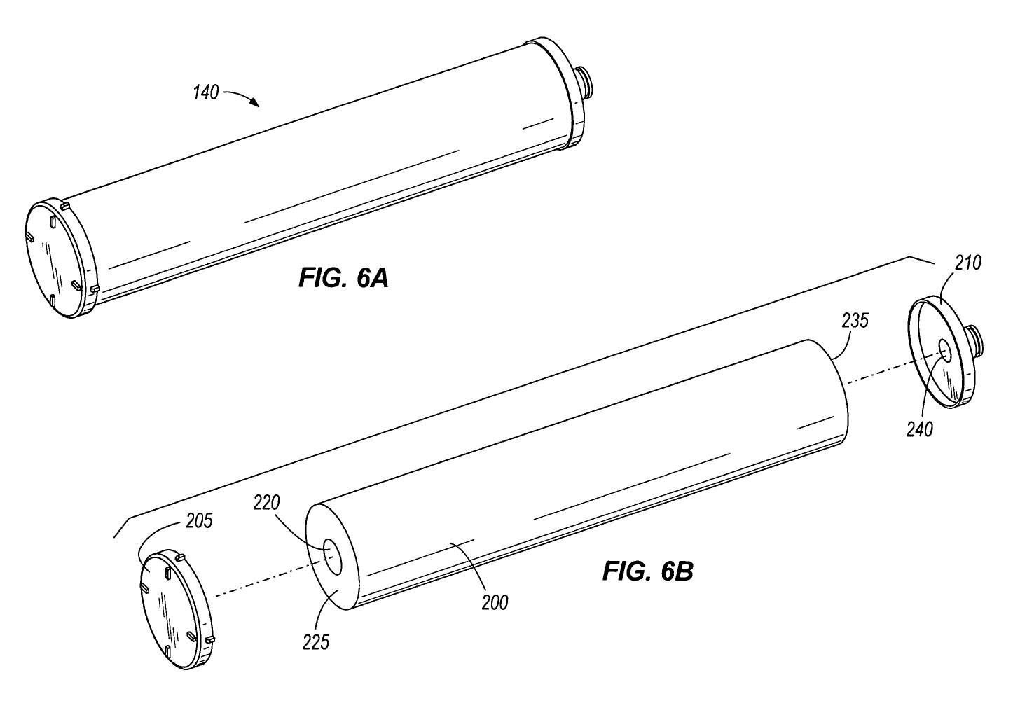

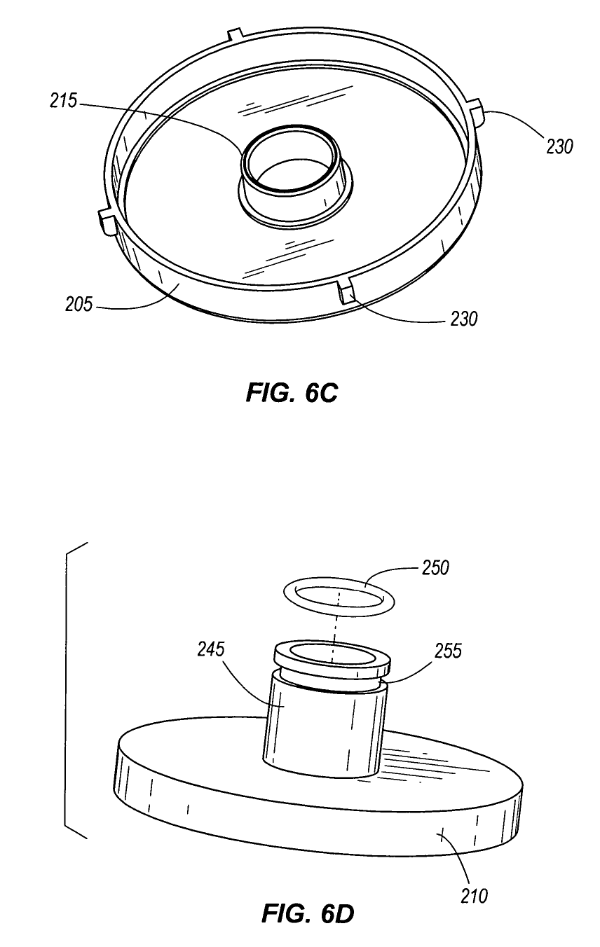

FIGS. 6A and 6B illustrate one embodiment of the filter sub-assembly 140. The filter sub-assembly 140 can include a filter element 200, a filter inlet end-cap 205, and a filter outlet end-cap 210. The filter element 200 can be in the shape of a tube and can be constructed of one or more suitable types of filter materials (e.g., activated charcoal) for different filtering applications (e.g., water, syrup).

As shown in FIGS. 6B and 6C, the filter end cap 205 can include a circular ridge 215 which can fit into an opening 220 of the filter element 200. The filter end cap 205 can prevent a liquid in the opening 220 of the filter element 200 from exiting a first end 225 of the filter element 200. The filter end-cap 205 can also include a plurality of support tabs 230. The support tabs 230 can be supported by the lip 175 of the inlet end-cap 110 to hold the filter sub-assembly 140 in position when the LVPO filter 100 is fully assembled.

The filter outlet end-cap 210 can fit over a second end 235 of the filter element 200. As shown in FIGS. 6B and 6D, the filter outlet end-cap 210 can include an opening 240 sized and positioned to cooperate with the opening 220 of the filter element 200. The opening 240 can run through a cylindrical neck 245. An o-ring 250 can be positioned in a groove 255 that extends circumferentially around the neck 245.

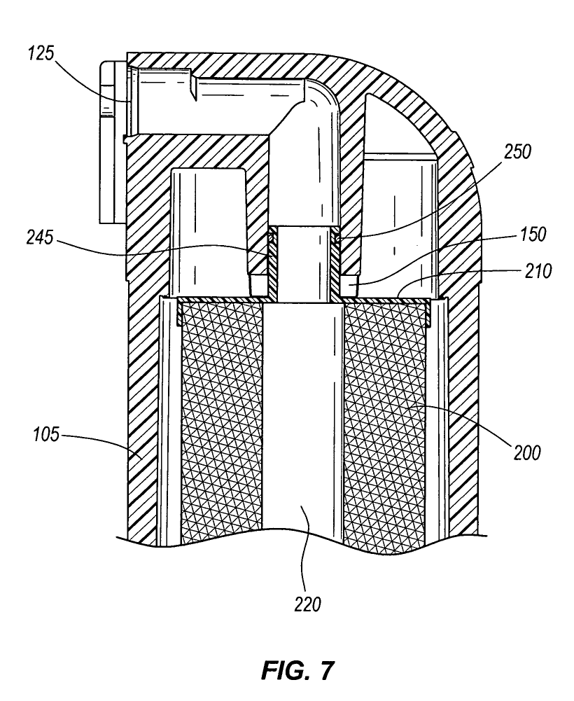

The filter sub-assembly 140 can be assembled by attaching the filter outlet end-cap 210 to the second end 235 of the filter element 200 and attaching the filter inlet end-cap 205 to the first end 225 of the filter element 200. The LVPO filter 100 can be assembled by inserting the filter sub-assembly 140 into the housing 105. The filter outlet end-cap 210 can be inserted into the housing 105 first so that the neck 245 of the filter sub-assembly 140 can enter the outlet port access 150. The o-ring 250 can form a seal between the neck 245 and the outlet port access 150, as shown in FIG. 7. The filter sub-assembly 140 can be positioned in the housing 105 with the filter outlet end-cap 210 flush against the outlet port access 150. Once the filter sub-assembly 140 is fully seated in the housing 105, the inlet end-cap 110 can be mounted to the housing 105. In some embodiments, the inlet end-cap 110 can be mounted to the housing 105 by screwing the inlet end-cap 110 into the housing 105. In some embodiments, the inlet end-cap 110 can be attached to the housing 105 with an adhesive.

In some embodiments, the LVPO filter 100 can be operated by accepting a liquid, under pressure, at the inlet port 120. The liquid can enter the inlet end-cap 110, which, because of its rounded or semi-circular shape, can induce a laminar flow in the liquid. The laminar flow can cause the liquid to flow with little or no turbulence. The lack of turbulence can reduce friction in the flow of the liquid and can enable the liquid to flow at a higher rate. The laminar flow can also reduce the pressure drop between the liquid at the inlet port 120 and the liquid at the outlet port 125 to between about one and two pounds per square inch.

The liquid can then be forced around the filter end-cap 205 and into the space between the housing 105 and the filter element 200. The pressure of the liquid between the housing 107 and the filter element 200 can build until the pressure is sufficient to force the liquid through the filter element 200. As the liquid moves through the filter element 200, the filter element 200 can remove impurities from the liquid. The filtered liquid can then enter the opening 220 in the filter element 200. Once the liquid fills the opening 220, the liquid can be forced through the opening 240 and into the neck 245 of the filter outlet end-cap 210. From the neck 245 of the filter outlet end-cap 210, the liquid can enter the outlet port access 150 of the housing 105, flow through the outlet tube 155, and out the outlet port 125.

In some embodiments, the LVPO filter 100 can achieve a flow rate of about three gallon per minute (“gpm”) as a result of its size and the reduced turbulence. The LVPO filter 100 can accommodate applications using in excess of about 500 gallons of liquid syrup or about 2500 gallons of water annually.

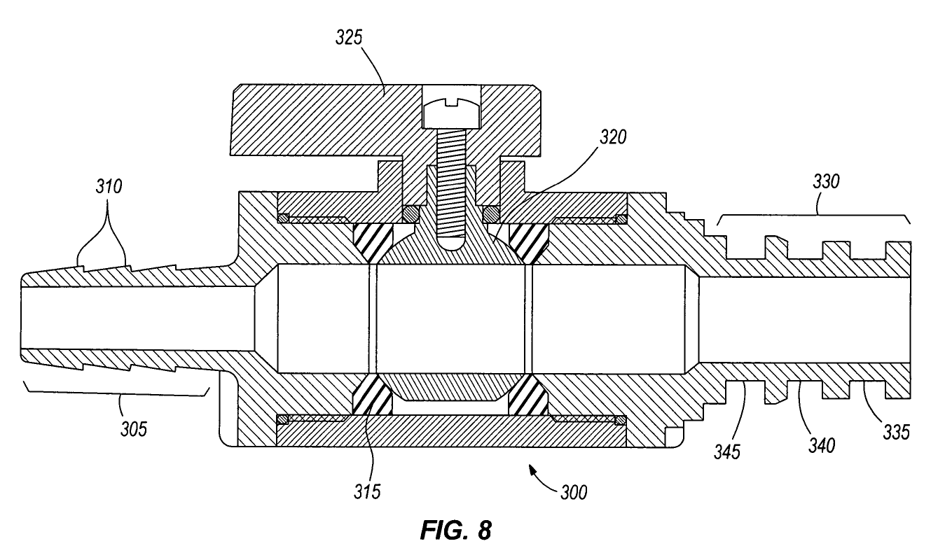

In some embodiments, a flow of liquid into the LVPO filter 100 can be shut off near the inlet port 120. FIG. 8 illustrates a quick disconnect ball valve 300 according to one embodiment of the invention for use with the LVPO filter 100. The quick disconnect ball valve 300 can shut off a flow of liquid to the LVPO filter 100. The quick disconnect ball valve 300 can include a barbed hose nozzle 305 having one or more barbs 310, a seat 315, a ball valve 320, a handle 325, and a quick disconnect nozzle 330. The quick disconnect nozzle 330 can have a first groove 335, a second groove 340, and a quick disconnect clip slot 345.

A hose (not shown), with an inside diameter approximately equal to an outside diameter of the barbed hose nozzle 305, can be slid over the barbed hose nozzle 305. The barbs 310 of the barbed hose nozzle 305 can help hold the hose in place. In some embodiments, the hose can also be clamped in place. The ball valve 320 can be operated by turning the lever 325 between a fully-open position (as shown in FIG. 8) where substantially all liquid is able to flow through the quick disconnect ball valve 300 and a fully-closed position where substantially no liquid is able to flow through the quick disconnect ball valve 300. In some embodiments, rotating the handle 325 about 90 degrees can move the ball valve 320 from its fully-open position to its fully-closed position or from its fully-closed position to its fully-open position.

Two o-rings (not shown) can be positioned in the first and second grooves 335 and 340. The quick disconnect nozzle 330 can be inserted into the inlet port 120 and the o-rings can provide a fluid-tight seal between the inlet port 120 and the quick disconnect nozzle 330. When the quick disconnect nozzle 330 is sufficiently inserted into the inlet port 120, a quick coupling clip 360 (as shown in FIG. 9) can be slid in the coupling guides 130 to mate with the quick disconnect clip slot 345 on the quick disconnect nozzle 3330 and secure the quick disconnect ball valve 300 to the LVPO filter 100.

After a period of use, the LVPO filter 100 can become dirty, lose effectiveness, and need to be replaced. FIG. 9 illustrates one embodiment of the interconnection between the LVPO filter 100, the quick disconnect ball valve 300, a quick disconnect coupler 365, and quick coupling clips 360. In some embodiments, the LVPO filter 100 can be replaced by first turning the lever 325 of the quick disconnect ball valve 300 to its fully-closed position. The quick coupling clip 360 can be slid off the quick disconnect clip slot 345 of the quick disconnect ball valve 300, and the quick disconnect ball valve 300 can be removed from the inlet port 120 of the LVPO filter 100. A similar quick coupling clip 360 at the outlet port 125 can be uncoupled from a quick disconnect coupler 365 in the outlet port 125. The coupler 365 can be removed from the outlet port 125 of the LVPO filter 100, and the LVPO filter 100 can then be removed. A new LVPO filter 100 can be installed by inserting the quick disconnect coupler 365 into the outlet port 125 of the new LVPO filter 100. The quick coupling clip 360 can then be coupled to the quick disconnect coupler 365. The quick disconnect ball valve 300 can be inserted into the inlet port 120 and the quick coupling clip 360 can be coupled to the quick disconnect ball valve 300. Finally, the lever 325 on the quick disconnect ball valve 300 can be turned to its fully-open position.

In some embodiments, the LVPO filter 100 can be used in series or parallel with other LVPO filters 100 to produce a “water factory.” The LVPO filter 100 can be used with recreation vehicles, boats, garden hoses, commercial ice makers, or commercial coffee makers. In some embodiments, the LVPO filter 100 can have a profile that enables the LVPO filter 100 to be used under a counter and/or with a beverage dispenser system.

Thus, the invention provides, among other things, a LVPO large in-line filter and a quick disconnect ball valve for fast and easy replacement of used filters. Various features and advantages of the invention are set forth in the following claims.

1. An in-line filter assembly comprising:
a filter sub-system;
a housing including an outlet, the housing receiving the filter subassembly;
an end-cap including an inlet and having a semi-spherical shape, the inlet and the end-cap producing a laminar flow; and
a valve coupled to the inlet port.

2. The assembly of claim 1 wherein at least one of the inlet and the outlet includes a quick connect coupling.

3. The assembly of claim 1 wherein at least one of the inlet and the outlet is perpendicular to a longitudinal axis of the housing.

4. The assembly of claim 1 wherein at least one of the inlet and the outlet includes a female coupling.

5. The assembly of claim 1 wherein a liquid flows through the in-line filter at a flow rate of at least about three gallons per minute.

6. The assembly of claim 1 wherein a first pressure of a liquid at the outlet is between about one and two pounds per square inch less than a second pressure of the liquid at the inlet.

7. The assembly of claim 1 wherein the valve is a ball valve.

8. The assembly of claim 1 wherein the valve includes a nozzle and two o-rings.

9. The assembly of claim 1 wherein the housing and the end-cap are injection molded.

10. The assembly of claim 1 wherein the in-line filter has a low profile.

11. The assembly of claim 1 wherein the in-line filter is mounted below a counter.

12. The assembly of claim 1 wherein a plurality of in-line filters form a water factory.

13. An in-line filter comprising:
an end-cap having a semi-spherical shape and an inlet, the end-cap and the inlet producing a laminar flow;
a housing including an outlet, the inlet and the outlet positioned substantially perpendicular to a longitudinal axis of the housing;
a filter sub-assembly positioned in the housing; and
quick connect couplings coupled to the inlet and the outlet.

14. The assembly of claim 13 wherein at least one of the inlet and the outlet includes a female coupling.

15. The assembly of claim 13 wherein a liquid flows through the in-line filter at a flow rate of at least about three gallons per minute.

16. The assembly of claim 13 wherein a first pressure of a liquid at the outlet is between about one and two pounds per square inch less than a second pressure of the liquid at the inlet.

17. The assembly of claim 13 and further comprising a ball valve coupled to the inlet.

18. The assembly of claim 17 wherein the ball valve includes a nozzle and two o-rings.

19. The assembly of claim 13 wherein the housing and the end-cap are injection molded.

20. The assembly of claim 13 wherein the in-line filter has a low profile.

21. The assembly of claim 13 wherein the in-line filter is mounted below a counter.

22. The assembly of claim 13 wherein a plurality of in-line filters form a water factory.

23. A method of replacing an in-line filter, the method comprising:
closing a valve;
uncoupling the valve from the in-line filter;
uncoupling a quick connect coupling from the in-line filter;
coupling the quick connect coupling to a new in-line filter;
coupling the valve to the new in-line filter; and
opening the valve.

24. The method of claim 23 and further comprising coupling the valve to an inlet port.

25. The method of claim 23 and further comprising coupling the quick connect coupling to an outlet port.
